(19) United States
(12) Patent Application Publication
(10) Pub. No.: US 2024/0146640 A1
(43) Pub. Date: May 2, 2024

(54) APPARATUSES, METHODS, AND SYSTEMS FOR DYNAMIC DATA PACKAGE ROUTING

(71) Applicant: CrowdPoint Technologies, Inc., Austin, TX (US)

(72) Inventor: Wolf Kohn, Philadelphia, PA (US)

(21) Appl. No.: 18/497,998

(22) Filed: Oct. 30, 2023

Related U.S. Application Data
(60) Provisional application No. 63/420,361, filed on Oct. 28, 2022.

(51) Int. Cl. H04L 45/00; H04W 40/02

(52) U.S. Cl. CPC H04L 45/14; H04W 40/02

(57) ABSTRACT

Apparatuses and methods are disclosed for dynamic data package routing. A method includes receiving criterion dynamics, constructing Dynkin operators in response to the criterion dynamics, constructing an interference matrix in response to the Dynkin operators, deploying an interference automaton equation in response to the interference matrix, performing prefix-loop decomposition to generate a control law, and outputting the control law.

### CROSS-REFERENCE TO RELATED APPLICATION

This application claims the benefit of U.S. Provisional Patent Application No. 63/420,361, filed Oct. 28, 2022, which is incorporated herein by reference in its entirety.

### FIELD

The subject matter disclosed herein relates generally to wireless communications and more particularly relates to apparatuses, method, and systems for dynamic data package routing.

### BACKGROUND

Currently, mobile 5G networks have an excess amount of available capacity. This is because mobile 5G network infrastructure has been upgraded from 4G to accommodate for 5G capacity. However, software routing performance lags, thus, the network does not truly deliver 5G performance. In other words, devices on the mobile 5G network are not optimized to take advantage of the excess capacity available on the network.

### SUMMARY

Methods for dynamic routing. Apparatuses and systems also perform the functions of the methods.

A method includes receiving criterion dynamics, constructing Dynkin operators in response to the criterion dynamics, constructing an interference matrix in response to the Dynkin operators, deploying an interference automaton equation in response to the interference matrix, performing prefix-loop decomposition to generate a control law, and outputting the control law.

An apparatus for wireless communication includes a processor and a memory coupled to the processor. The processor is configured to cause the apparatus to receive criterion dynamics, construct Dynkin operators in response to the criterion dynamics, construct an interference matrix in response to the Dynkin operators, deploy an interference automaton equation in response to the interference matrix, perform prefix-loop decomposition to generate a control law, and output the control law.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for performing dynamic package routing;

FIG. 2 is a schematic block diagram illustrating one embodiment of an apparatus that may be used as a scheduling user equipment;

FIG. 3 is a schematic block diagram illustrating one embodiment of an apparatus that may be used for selection of a scheduling user equipment;

FIG. 4 is a schematic block diagram illustrating transitions in a block chain from a given source block;

FIG. 5 illustrates a transition between blobs of the block chain of FIG. 4;

FIG. 6 is a flow diagram for operations performed at or for the blobs of FIG. 4;

FIG. 7 is an equation illustrating one embodiment of dynamic stage transition;

FIG. 8 is a protocol illustrating one embodiment of dynamic stage transition;

FIG. 9 is a rule illustrating one embodiment of dynamic stage transition;

FIG. 10 is a process illustrating one embodiment of optimization;

FIG. 11 is a process illustrating one embodiment of dynamic programming of a multistage block chain;

FIG. 12 is a process illustrating one embodiment of a dynamic programming optimization flow process;

FIG. 13 illustrates Dynkin operators;

FIG. 14 is a process illustrating one embodiment of a dynamic programming Bellman execution process using Dynkin operators;

FIG. 15 illustrates operators formed in accordance with an embodiment;

FIG. 16 is a schematic block diagram illustrating one embodiment of a dynamic programming algorithm;

FIG. 17 is a process illustrating one embodiment of inference automation dynamics;

FIG. 18 is an algorithm illustrating one embodiment of an automation transition algorithm;

FIG. 19 is a process illustrating one embodiment of construction of the automaton transition matrix;

FIG. 20 is an algorithm illustrating one embodiment of solvability of an automaton inference process;

FIG. 21 is an algorithm illustrating one embodiment of a decomposition of the automaton transition process;

FIG. 22 shows algorithms illustrating one embodiment of state representation of an inference automaton;

FIG. 23 is an algorithm illustrating one embodiment of an inference N-level automaton decomposition;

FIG. 24 is a schematic block diagram illustrating one embodiment of inference automaton decomposition;

FIG. 25 is a schematic block diagram illustrating one embodiment of inference automaton decomposition;

FIG. 26 is a schematic block diagram illustrating one embodiment of aggregation of the inference automaton;

FIG. 27 is a schematic block diagram illustrating one embodiment of automaton unitary decomposition components;

FIG. 28 is a schematic block diagram illustrating one embodiment of automaton unitary decomposition components;

FIG. 29 is a schematic block diagram illustrating one embodiment of automaton unitary decomposition components;

FIG. 30 is a flow diagram illustrating one embodiment of inference automaton execution;

FIG. 31 is a flow diagram illustrating one embodiment of stage transitions;

FIG. 32 is a flow diagram illustrating one embodiment of routing from a source to a target in a network environment;

FIG. 33 is a flow diagram illustrating one embodiment of routing from a source to a target in a network environment; and

FIGS. 34A-E are respective flow diagrams illustrating one embodiment of an inference automaton process.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

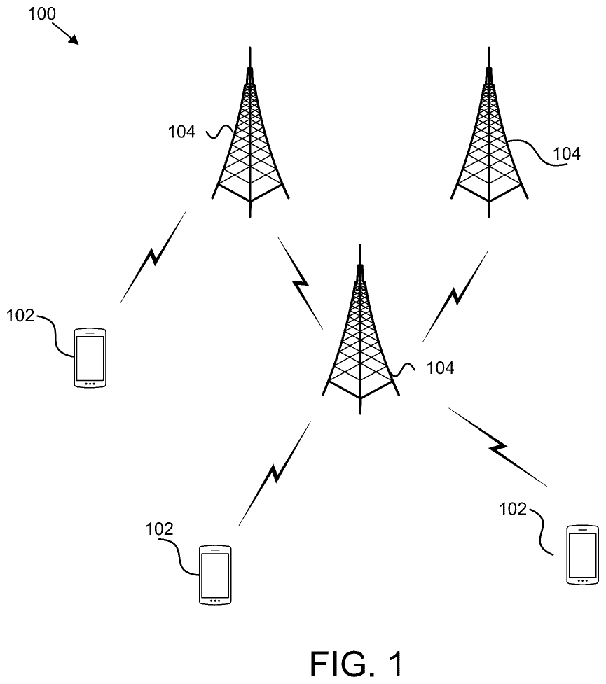

FIG. 1 depicts an embodiment of a wireless communication system 100 for dynamic package routing. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 3GPP protocol, wherein the network unit 104 transmits using an orthogonal frequency division multiplex (“OFDM”) modulation scheme on the DL and the remote units 102 transmit on the UL using a SC-frequency division multiple access (“FDMA”) scheme or an OFDM scheme. More generally, however, the wireless communication system 100 may implement some other open or proprietary communication protocol, for example, WiMAX, among other protocols. The present disclosure is not intended to be limited to the implementation of any particular wireless communication system architecture or protocol.

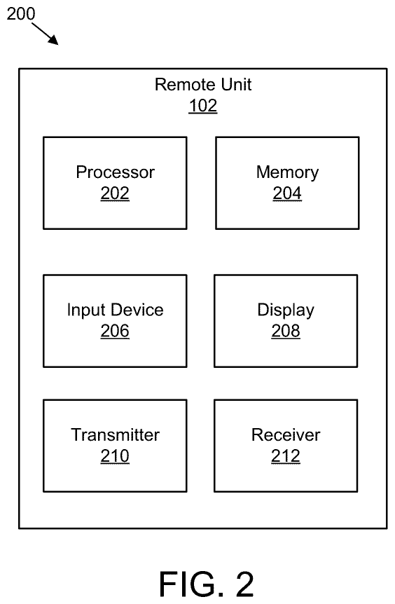

FIG. 2 depicts one embodiment of an apparatus 200 that may be used for dynamic package routing. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

The transmitter 210 is used to provide UL communication signals to the network unit 104 and the receiver 212 is used to receive DL communication signals from the network unit 104, as described herein. Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

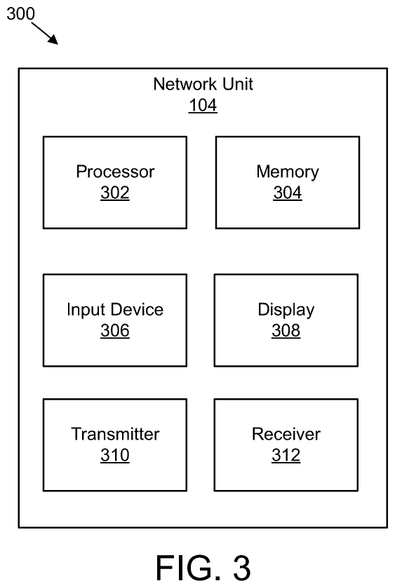

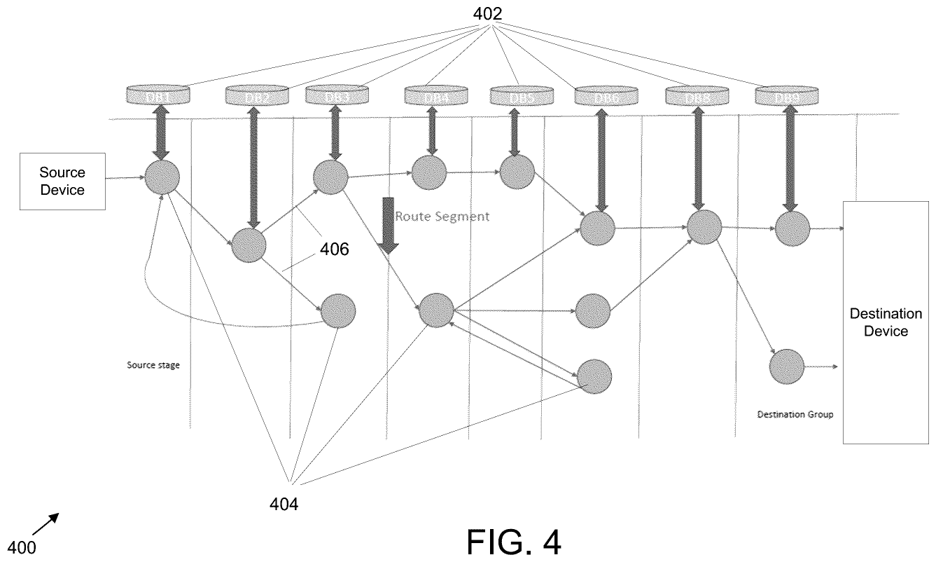

FIG. 3 depicts one embodiment of an apparatus 300 that may be grouped with other apparatuses 300 to form groups of nodes (“blocks” or “blobs”) 404 (see, e.g., FIG. 4) across a network 400 (see, e.g., FIG. 4). Accordingly, each blob 404 can include one apparatus 300 or multiple apparatuses 300. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

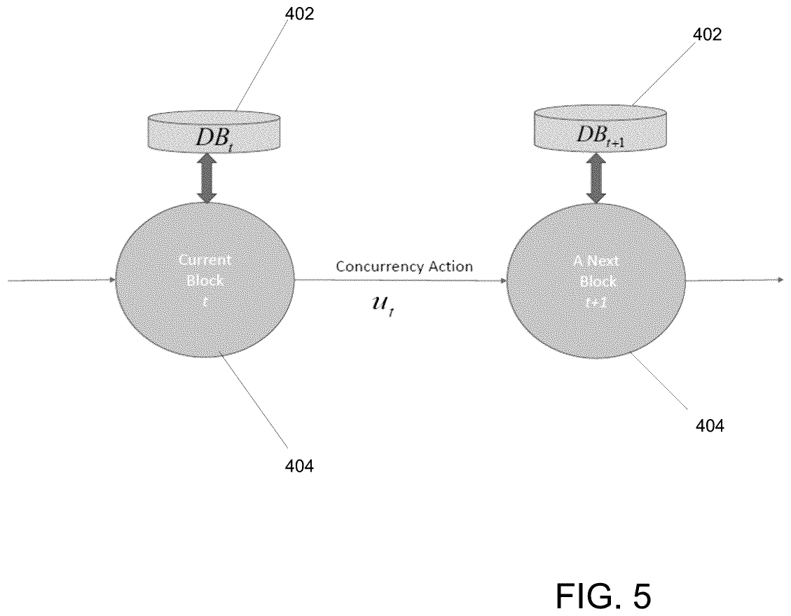

Referring to FIG. 4, in various embodiments, a diagram 400 of the present disclosure shows block chain transitions in a block chain from a given source block (e.g., source device) to a destination block (e.g., destination device or target) as performed by a multistage process. FIG. 4 shows a nondeterministic multistage flow of a message through sequence of blobs 404. Each component flow loads instances of operational rules. At each stage, a model incorporates information to blobs 404 in a given stage from a database 402 or databases 402 associated with the given stage in a path 406 of a chain being generated. A stage is a time dependent fragment of a routing algorithm associated with the current block/blob 404. A stage is associated with a blob 404 or more than one blob 404. A stage may not be associated with a blob 404, thereby initiating a restart from the previous successful blob 404. A chain is a number of blobs 404 connected via paths 406 from the source device to the destination device. The multistage process is performed using a distributed algorithm that generates block chain transition trajectories and corresponding concurrency actions. The multistage process performs optimization for selecting optimal feedback concurrencies connecting the blobs 404. An optimizations trajectory is recursive decomposition hereinafter termed an inference automaton (“IA”), which can be a state abstract machine. Synthesis of an implementation of IA involves a prefix-unitary decomposition. At each stage, the multistage process incorporates information of the blobs 404 in a stage from an appropriate database 402. The multistage process may be a distributed algorithm. FIG. 5 illustrates a transition between two blobs 404.

The process is formulated as an optimization problem to select Optimal Feedback Concurrencies connecting the blobs. The optimization trajectory is specified by a Dynamic Programming Algorithm (“DP”). The DP is executed by a computable structure called Inference Automaton (“IA”), which is a state abstract machine. The synthesis of an implementation of IA involve a Prefix-Unitary decomposition. The computability is illustrated with a small complexity test.

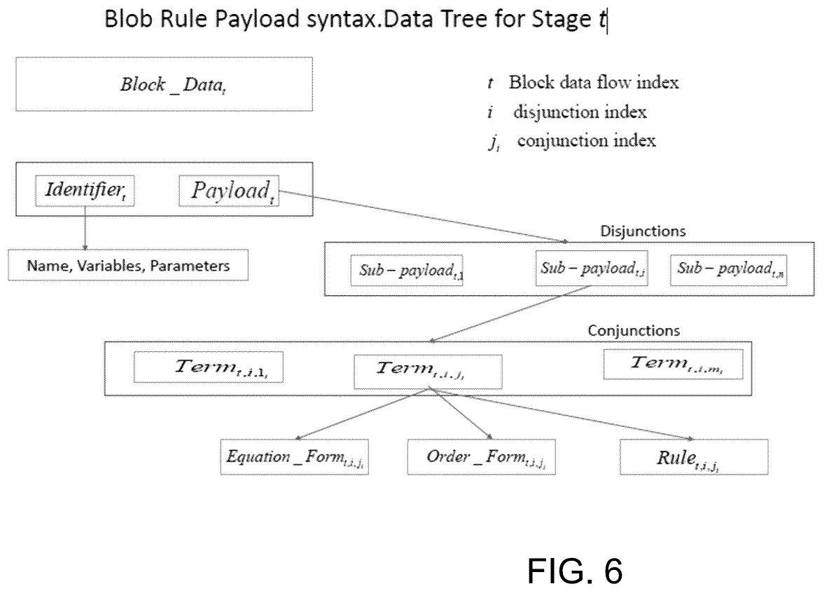

In FIGS. 6-16, a blob payload and route transition of each of stage of a blob route trajectory has been reformulated via Dynkin operators as a set of simultaneous equations. The IA reduces the number of uninstantiated variables at each block stage so that at the block corresponding to the end block of the chain all the variables are instantiated. The IA solves the trajectory equations of the source blob through autonomous stage-to-stage transitions.

FIG. 6 illustrates syntax of each rule for the operation of the blobs 404.

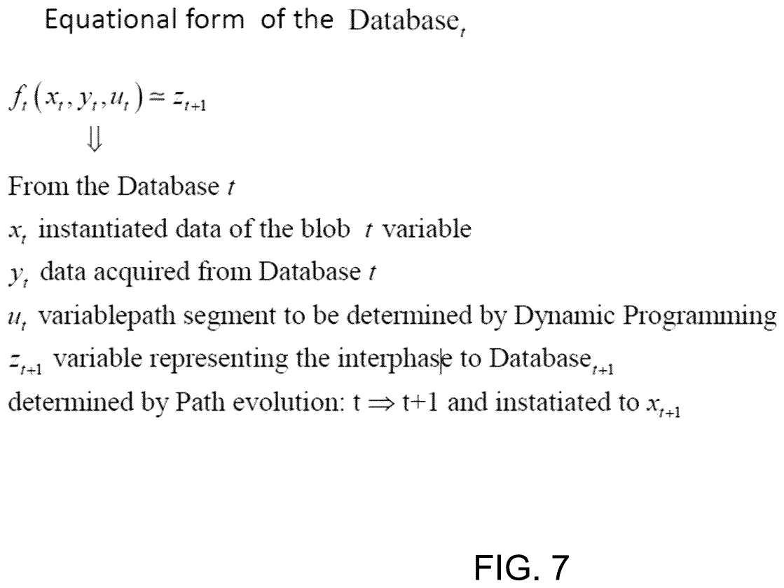

Referring to FIG. 7, at execution, the instance of the rules determines a dynamic stage transition (i.e., the state variable vector) that carries the current blob status of the initiated message. The y vector carries configuration requirements of the blob 404. The u vector, determined by the DP, determines the evolution of the message.

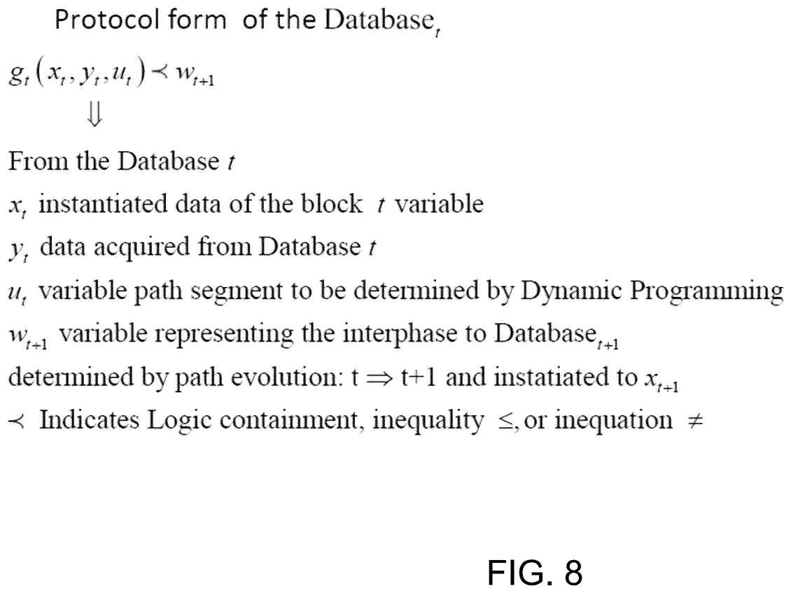

Referring to FIG. 8, the protocol of the next stage is determined whether it belongs to a different network.

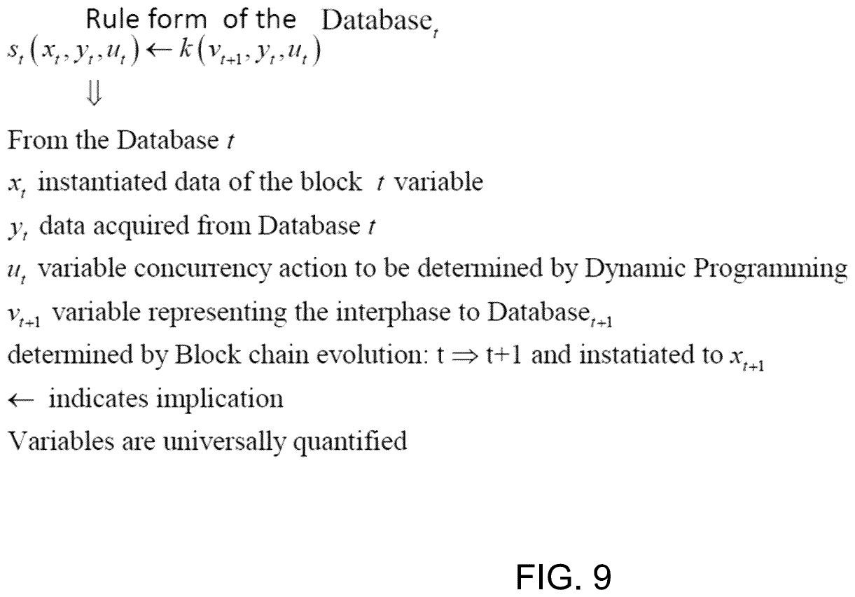

Referring to FIG. 9, an instance of a rule from the database is determined.

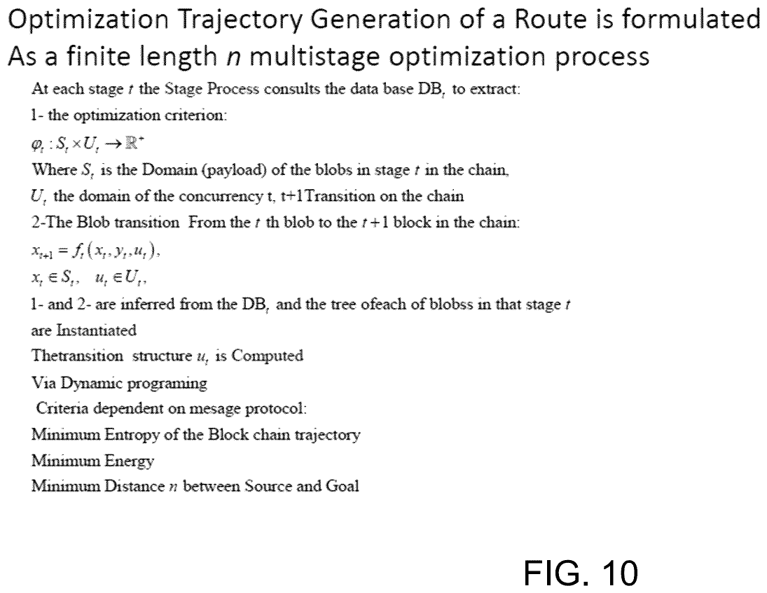

FIG. 10 shows a generic optimization process for calculating transitions between the blobs 404.

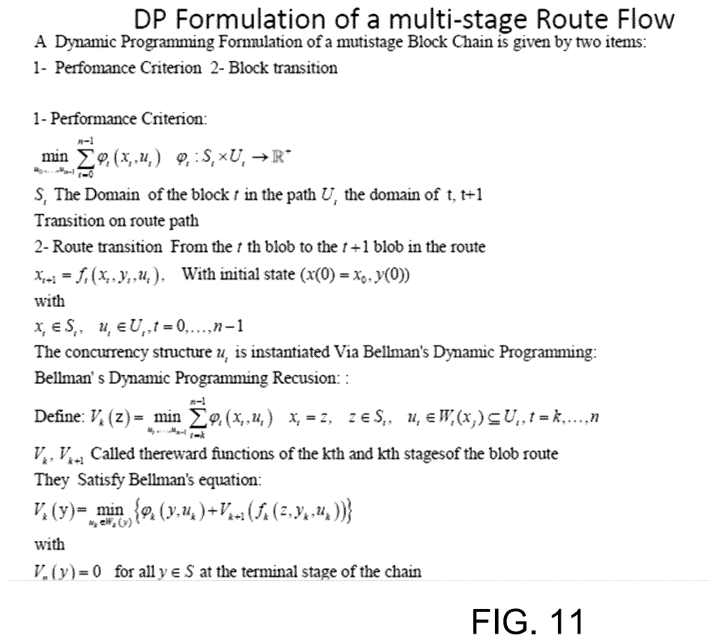

FIG. 11 shows an exemplary DP optimization flow process.

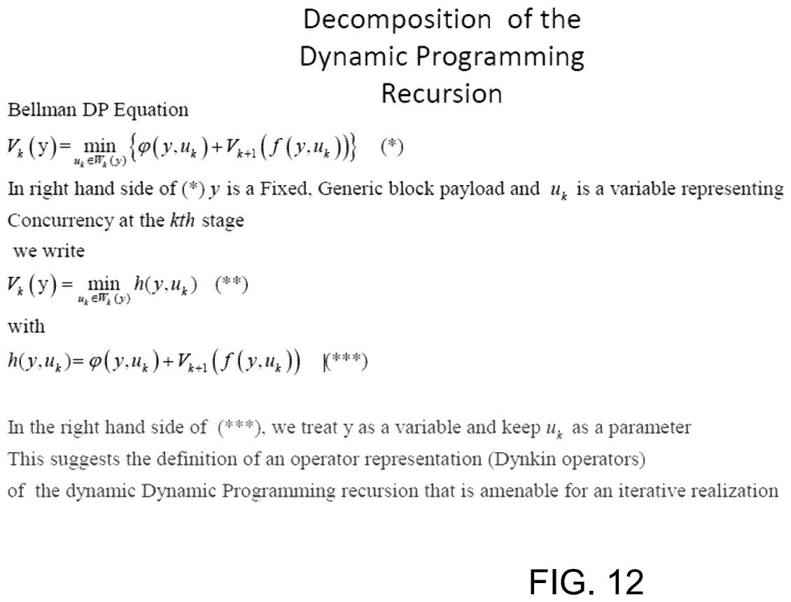

FIG. 12 shows decomposition of the DP optimization flow process into two sub-steps: 1) computing the state (message) transition; and 2) a sub-step to compute action that determines the next blob 404. Decomposition is computed via Dynkin operators.

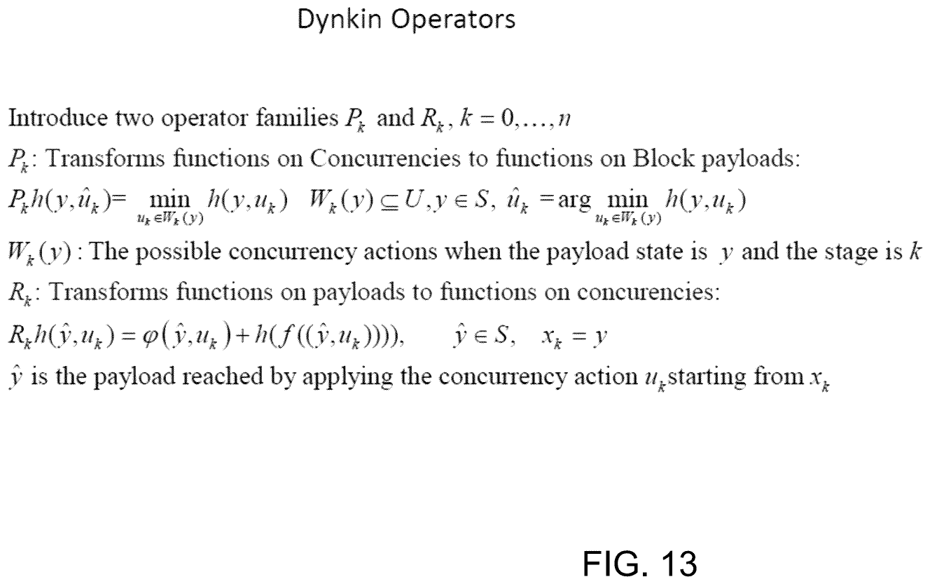

FIG. 13 shows definitions of Dynkin operators.

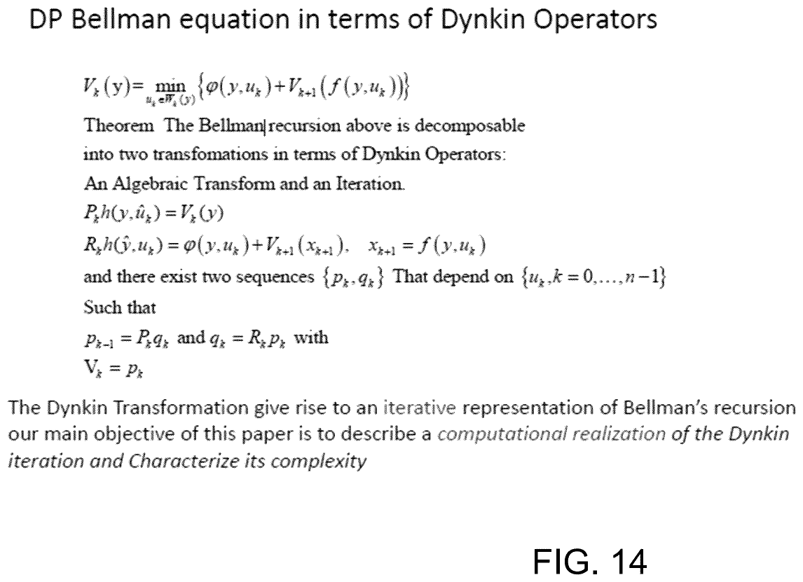

FIG. 14 shows a DP Bellman execution process via Dynkin operators. The Dynkin transformation gives rise to an iterative representation of Bellman's recursion.

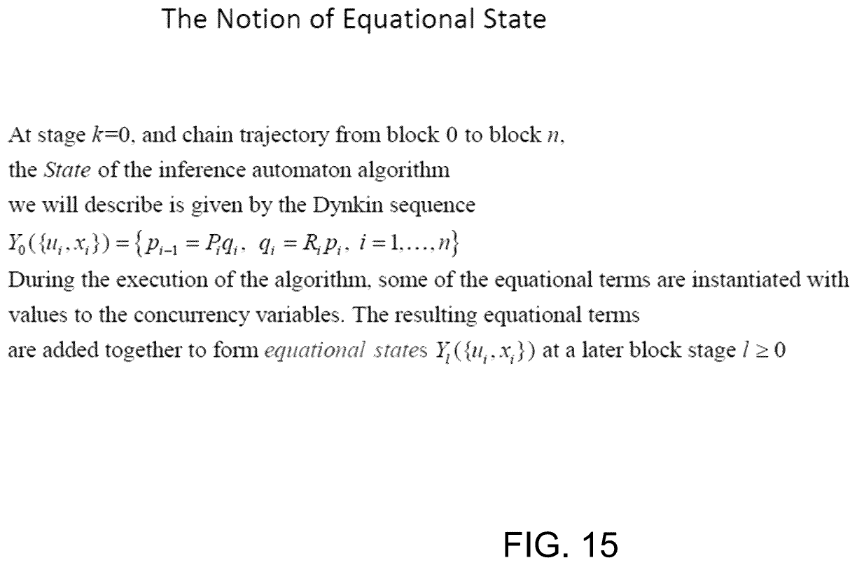

Referring to FIG. 15, at each blob 404 in the message flow active rules are translated to equational forms in terms of the Dynkin operators.

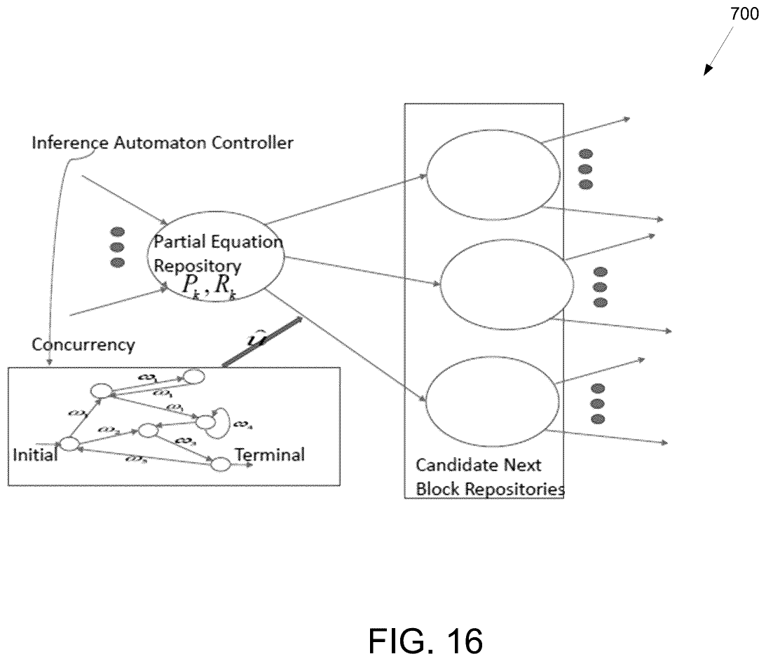

FIG. 16 shows automaton representation of the DP algorithm into a two-stage process. A stage transition of equational states is determined by a concurrency automaton determining the edge transition action(s). An IA transition graph 700 is shown. An IA controller is an iterative computable representation using the Dynkin Operators. The transition in general is not deterministic and selection of a next stage is determined by selecting as a next block the one that has the highest instantiation of the payload variables.

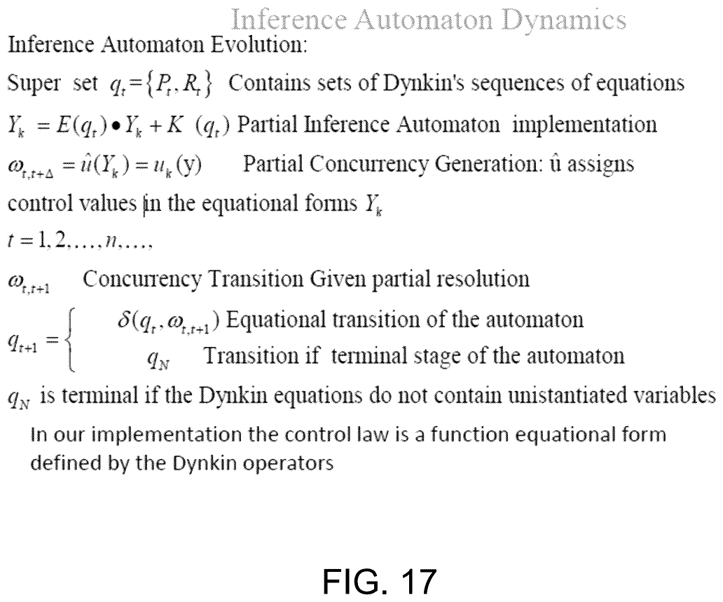

FIGS. 17-21 relate to the IA transition graph 700. FIG. 17 shows an exemplary automaton execution process.

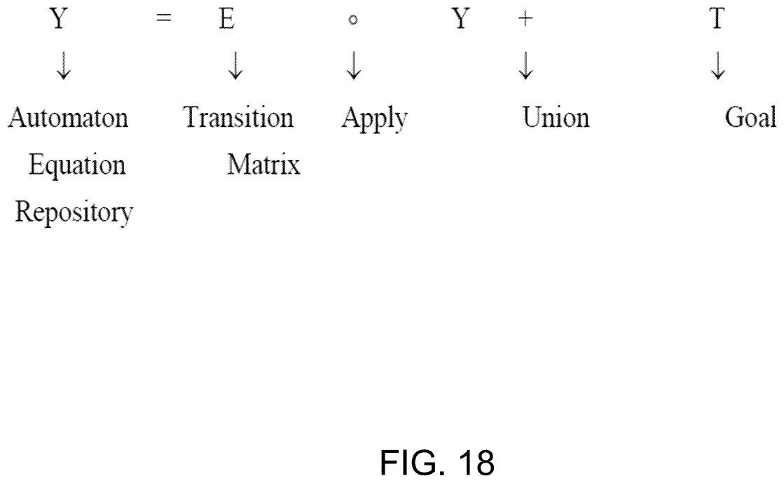

FIG. 18 shows an exemplary algorithm for automaton transition.

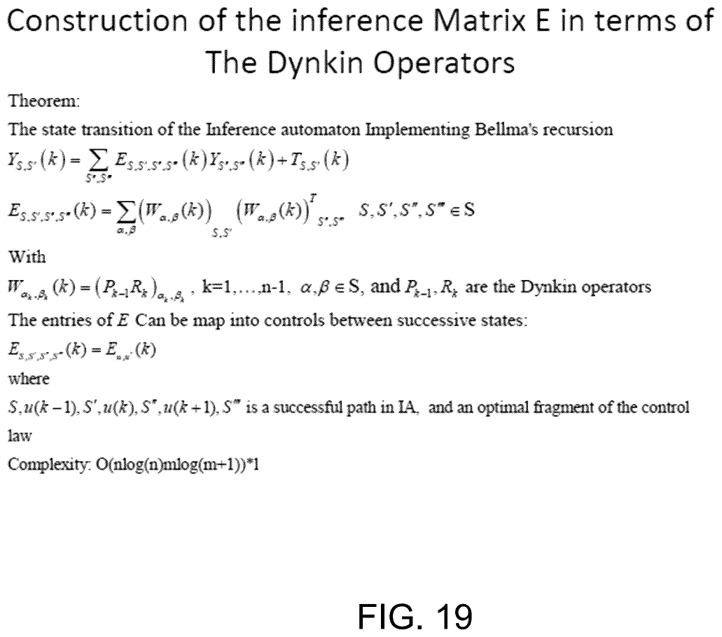

FIG. 19 shows construction of the automaton transition matrix E.

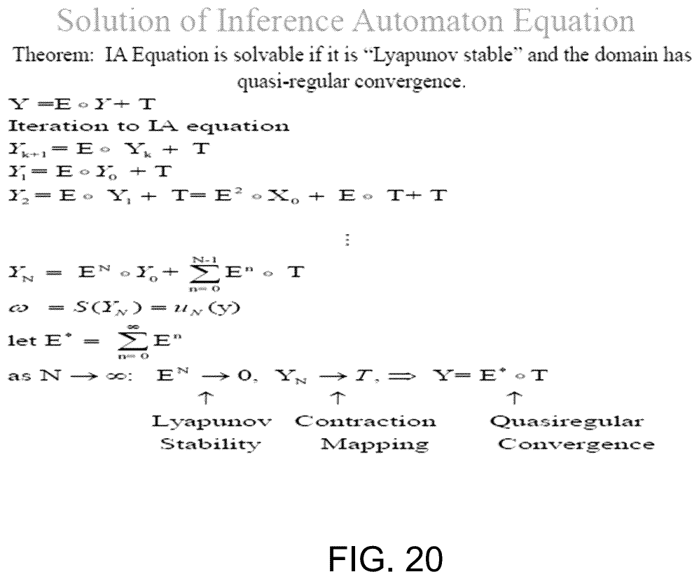

FIG. 20 shows solvability of the automaton inference process.

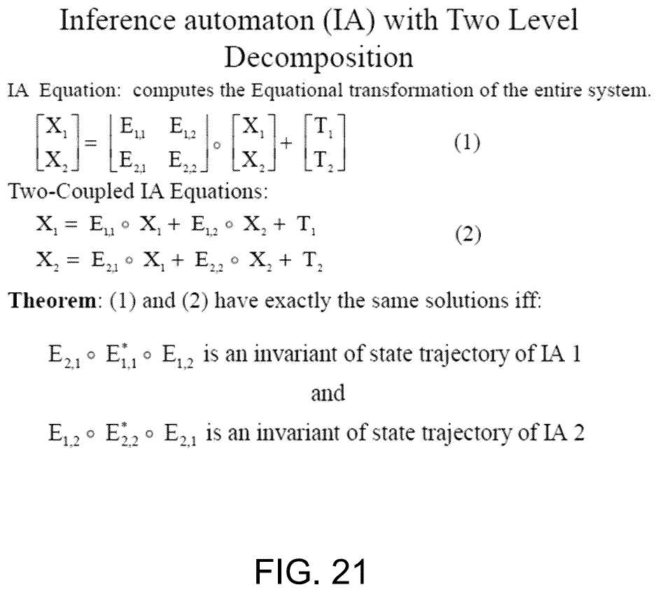

FIG. 21 shows decomposition of the automaton transition process.

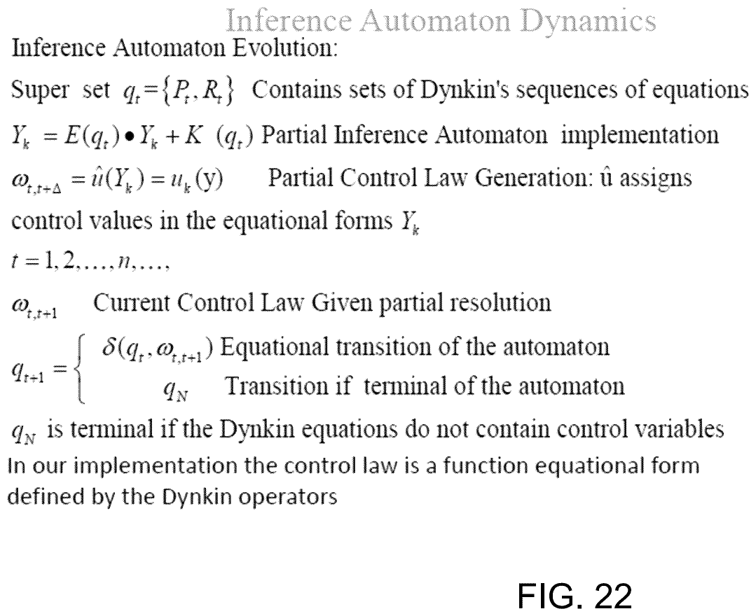

FIG. 22 shows state representation of the inference automaton.

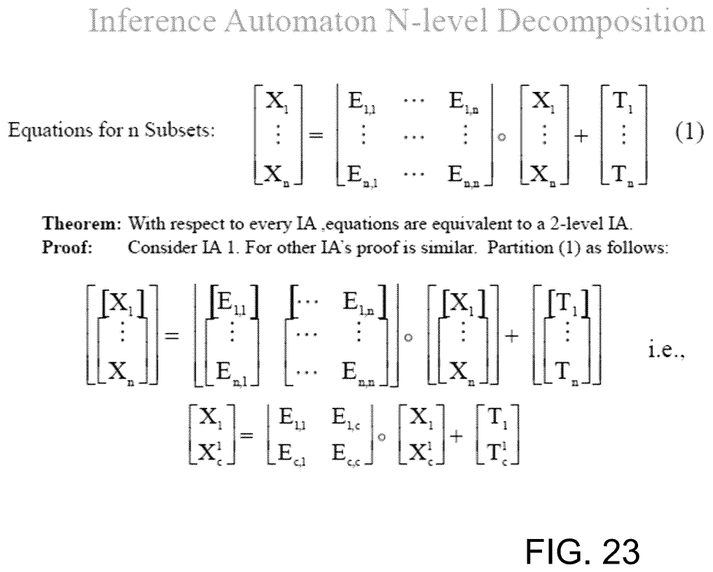

FIG. 23 shown inference N-level automaton decomposition.

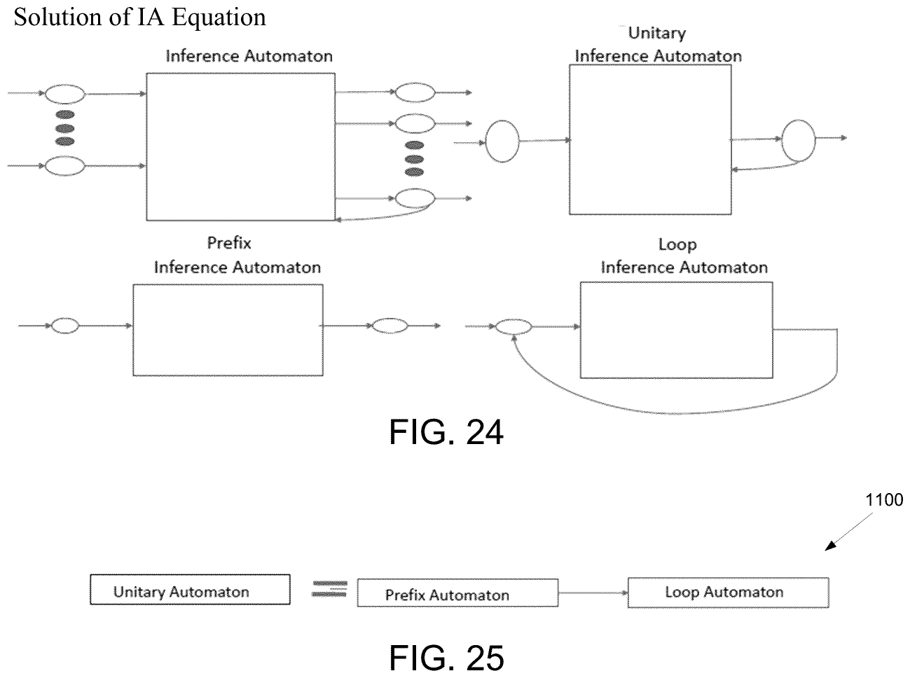

FIGS. 24 and 25 shown a block diagram of inference automaton decomposition. N inputs to the IA and M outputs from the IA are decomposed into N×M unitary IA's.

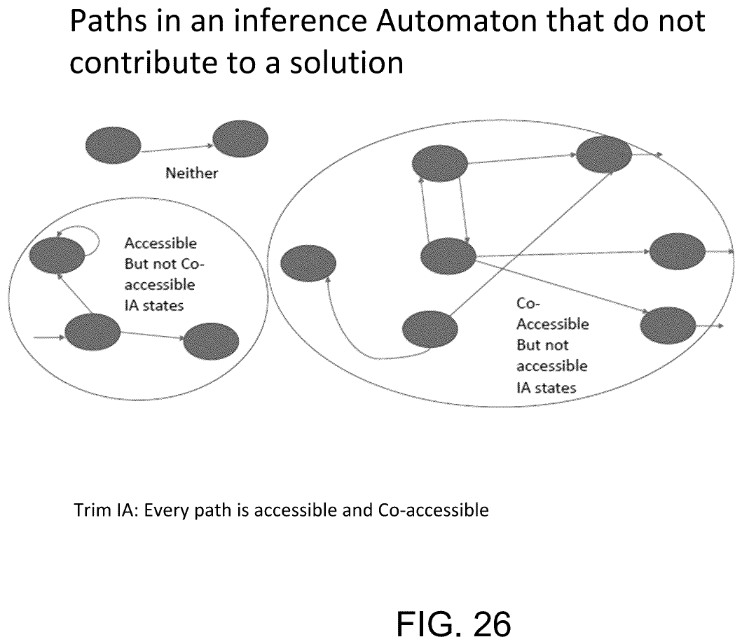

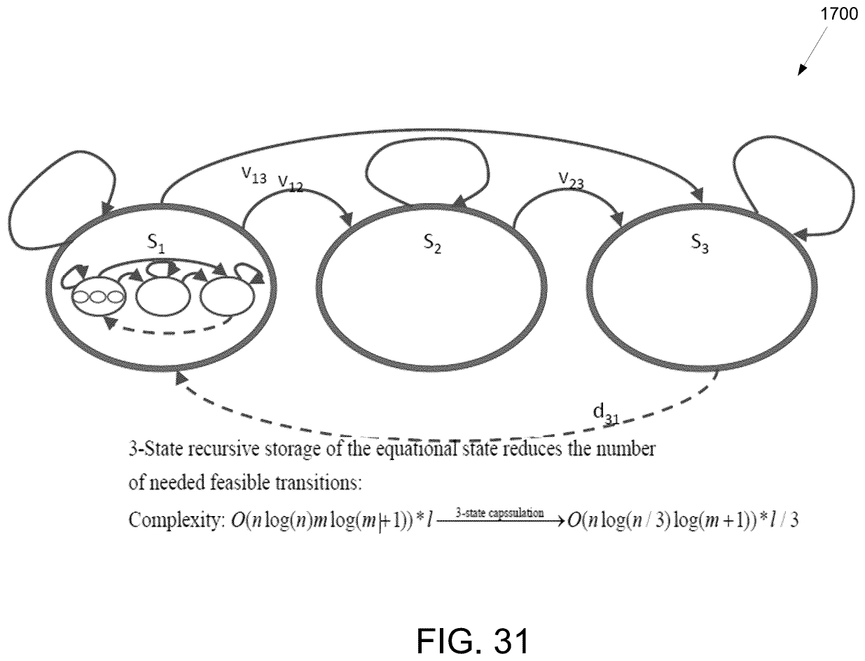

FIG. 26 shows aggregation of the IA in a recursive 3 state group into reduce execution complexity. FIG. 31 also shows resulting paths form inference automaton that do not provide a solution.

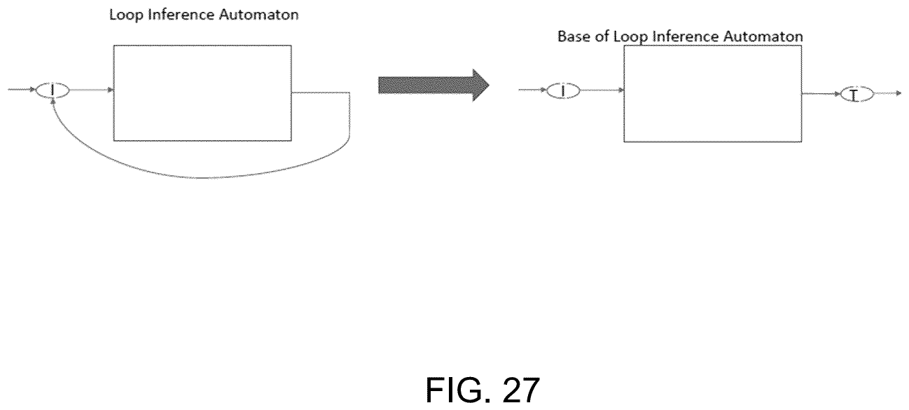

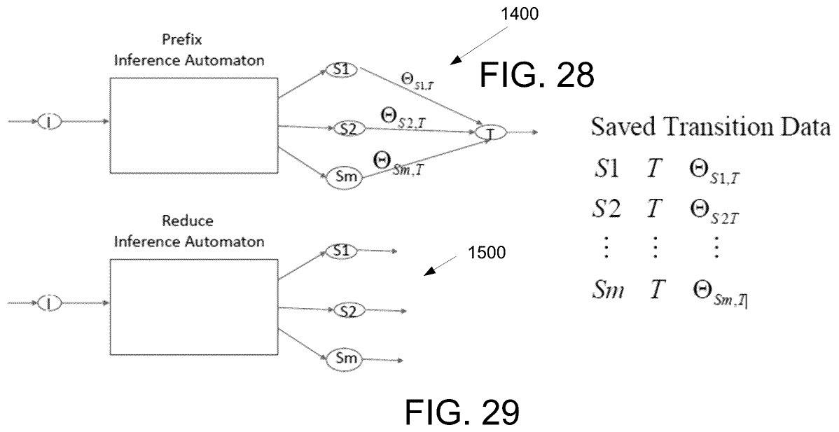

FIGS. 27-29 show automaton unitary decomposition components. Base of loop IA creates a terminal state T not included in the states of the original loop automaton, connects to T all the transitions terminating in state I, trims resulting unitary IA, and trims automaton is base of the loop automaton.

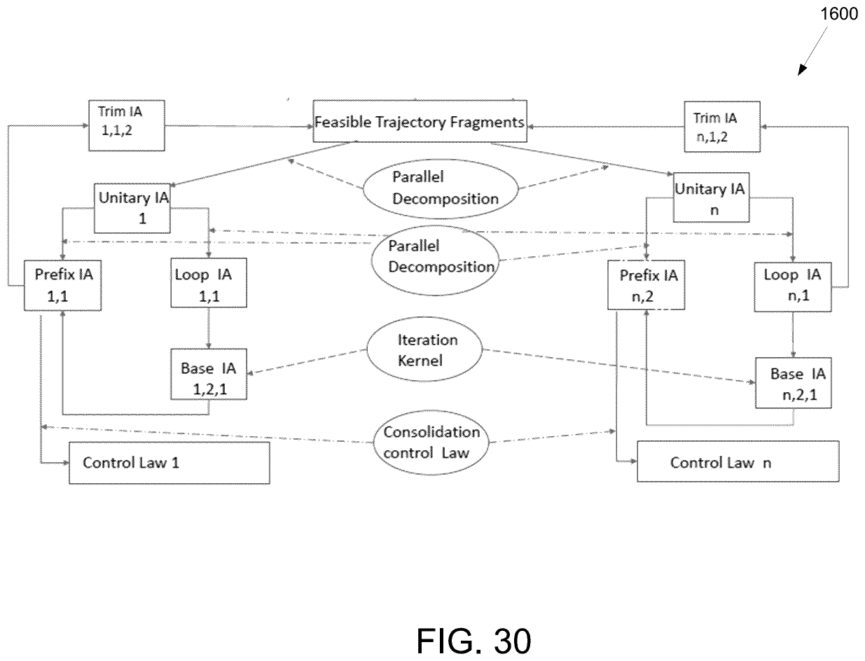

FIG. 30 shows an inference automaton execution process.

FIG. 31 shows a 3-state recursive storage of equational state to reduce the number of needed feasible transitions.

A decomposable, iterative implementation of blob multistage DP is developed. Concurrency transitions (decision) law is provided by the IA. The IA computes iterative partial forms of the feedback blob transition law as a function of the Dynkin operators associated with the DP equation. The state of the computation of a chain stage is given by partial instantiations of Dynkin equational forms that characterize the state of the corresponding node.

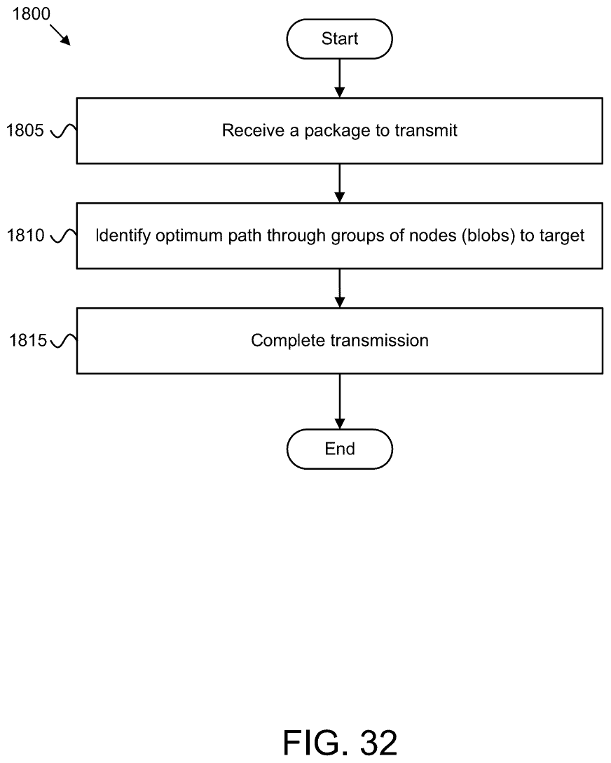

Referring to FIG. 32, a flow diagram of a method 1800 provides routing from a source to a target in a network environment having many network nodes lumped into groups of nodes or blobs. At a block 1805, a data package is received from the source for delivery to the target. At a block 1810, an optimum path through the network (blobs) to the target is identified. At a block 1815, transmission of the data packet to the target is completed based on the identified optimum path.

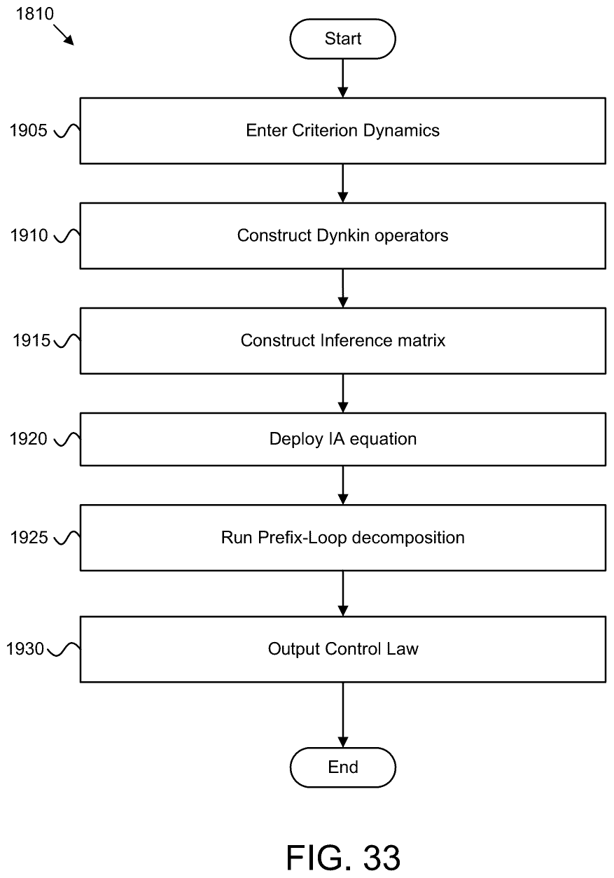

Referring to FIG. 33, a flow diagram that provides additional details for the step 1810 of the method 1800 of FIG. 32. At a block 1905, criterion dynamics are entered. At a block 1910, Dynkin operators are constructed based on the criterion dynamics. At a block 1915, an Inference matrix is constructed based on the Dynkin operators. At a block 1920, an IA equation is deployed based on the Inference matrix. At a block 1925, Prefix-Loop decomposition is run to generate a control law. At a block 1930, the control law is outputted.

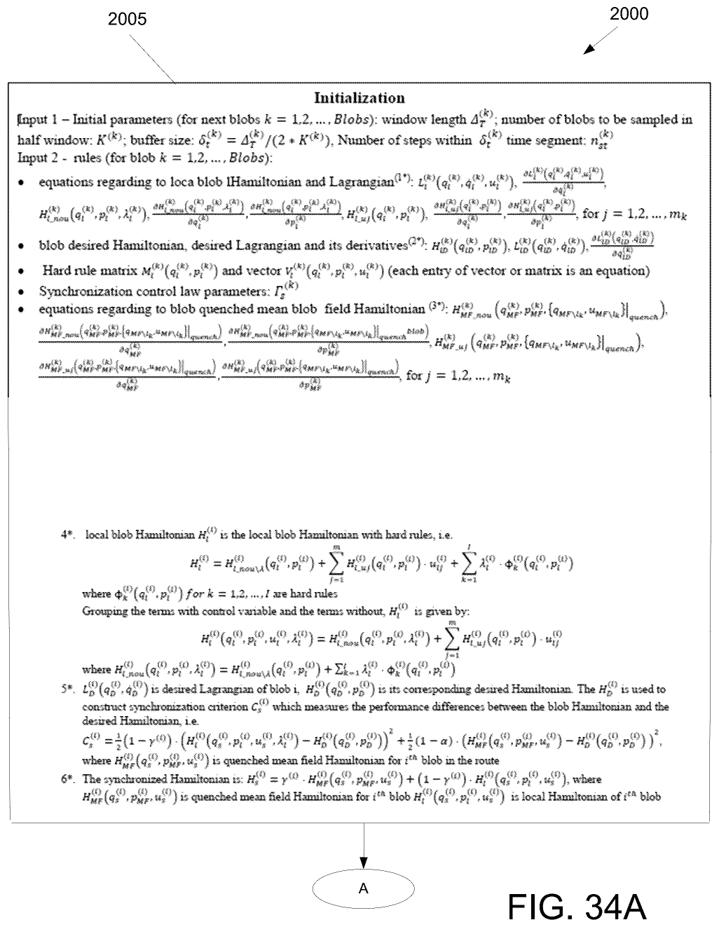

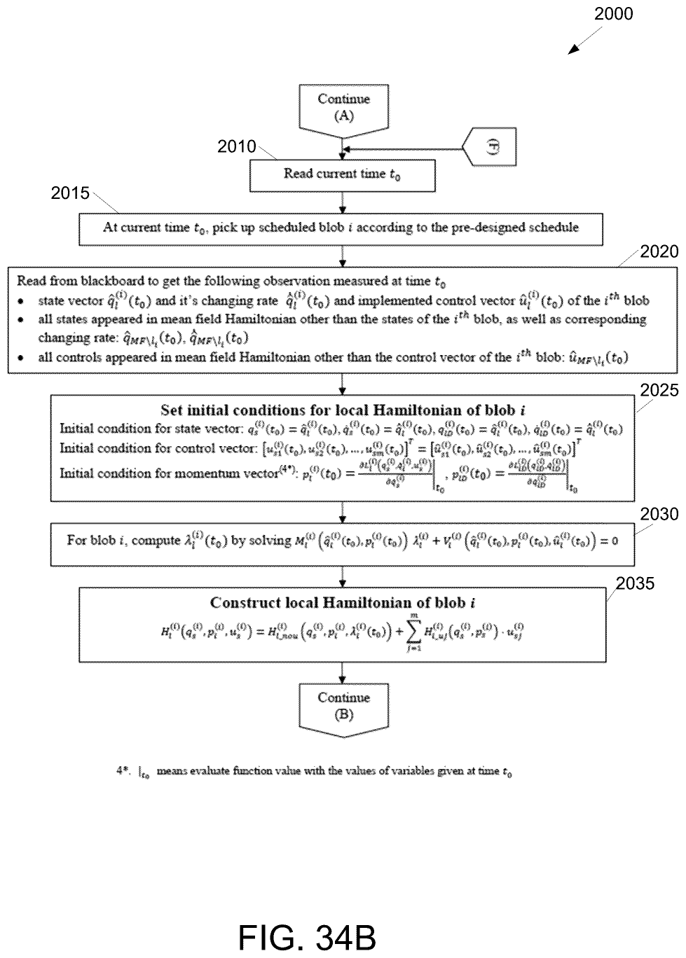

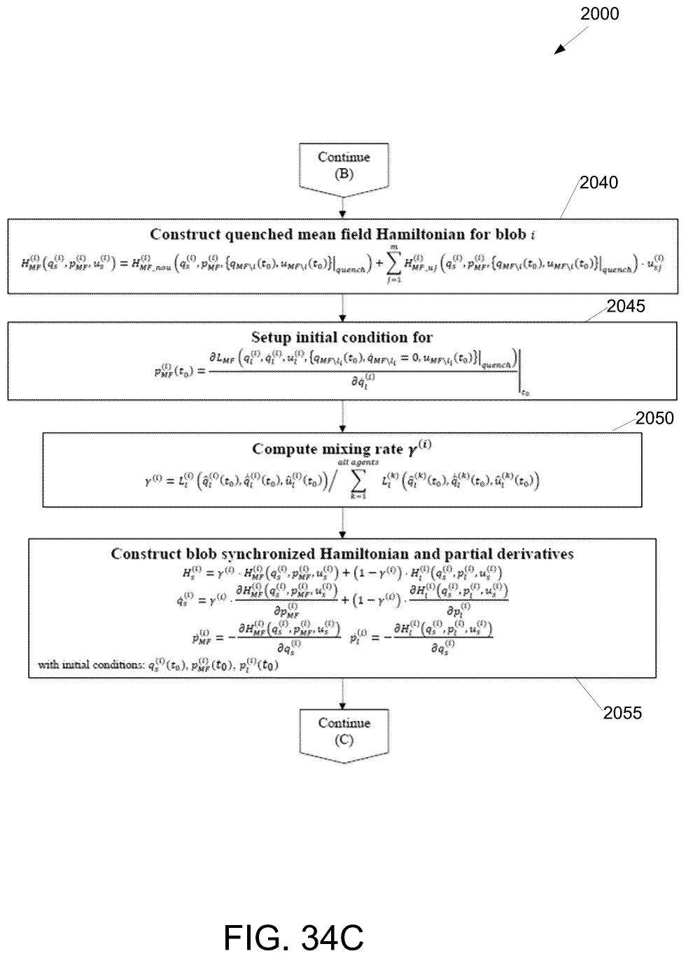

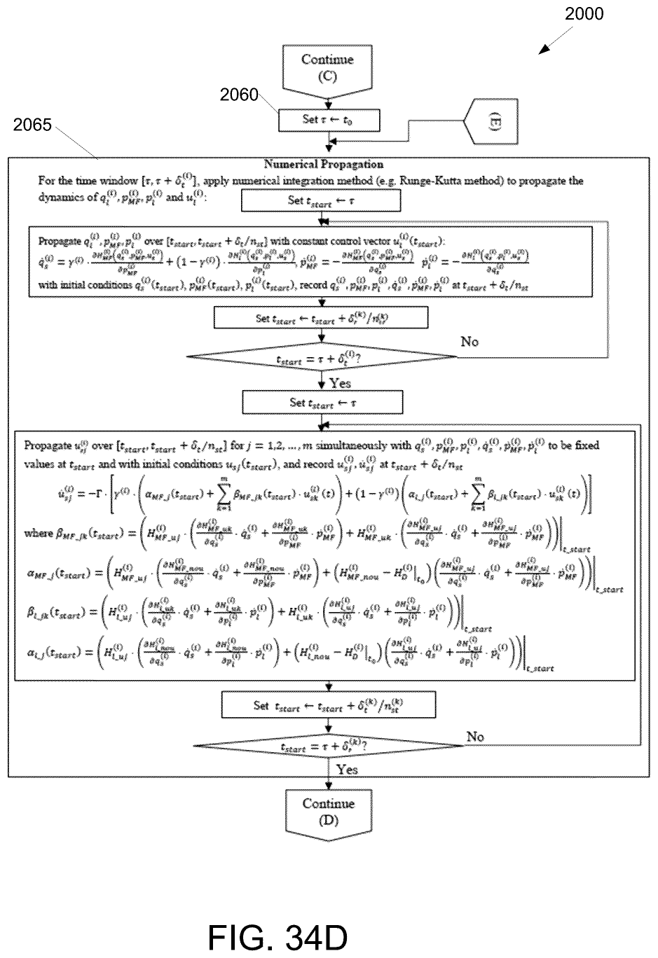

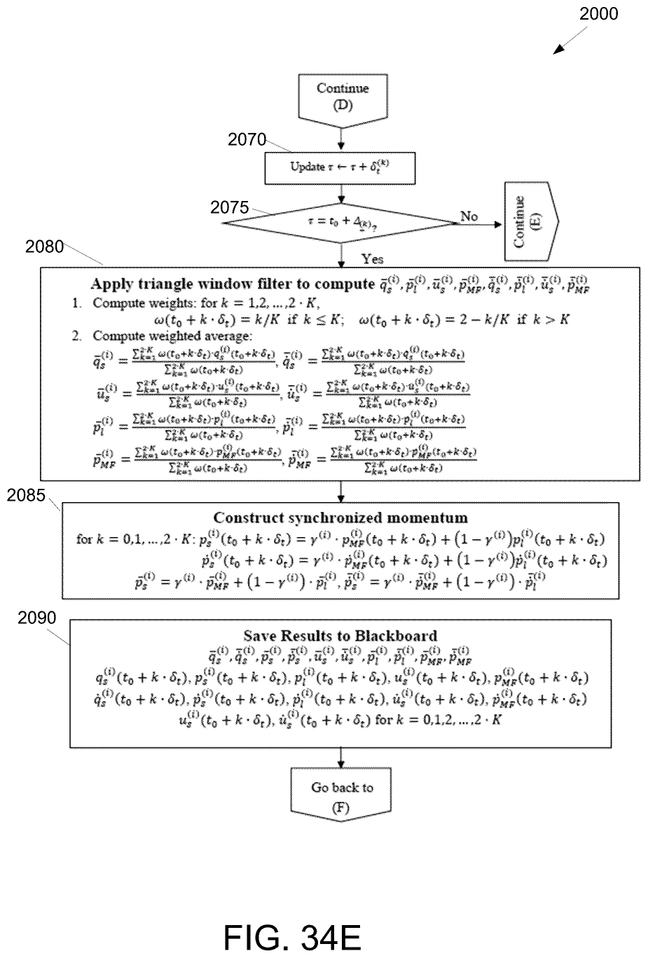

FIGS. 34A-E show a detailed implementation process of the inference automaton process. At a block 2005, initialization of parameters occurs. The initial parameters include window length, number of blobs to be sampled in a half window, buffer size, number of steps within a time segment. At a block 2010, current time is read. At a block 2015, at a current time scheduled blob is picked up according to a pre-designated schedule. At a block 2020, a blackboard is read to get observations measured at the current time. The observations include a state vector and state vector changing rate, implemented control vector of the current blob, and all states and all controls appearing in mean field Hamiltonian other than the current blob. At a block 2025, initial conditions for local Hamiltonian of blob i is set. The initial conditions include state vector, control vector, and momentum vector. At a block 2030, a λ value is computed for blob i. At a block 2035, a local Hamiltonian of blob i is constructed using the initial parameters and other previously calculated values. At a block 2040, a quenched mean field Hamiltonian for blob i is constructed using previously created parameters. At a block 2045, initial conditions are set up. At a block 2050, a mixing rate is computed. At a block 2055, blob synchronized Hamiltonian and partial derivatives are constructed. At a block 2060, a time value is set. At a block 2065, numerical propagation is performed. Blocks 2070 and 2075 relate to updating a time value. At a block 2080, a triangle window filter is applied to compute various values. At a block 2085, synchronized momentum is constructed. At a block 2090, the synchronized momentum results are saved to a blackboard.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving criterion dynamics;
constructing Dynkin operators in response to the criterion dynamics;
constructing an interference matrix in response to the Dynkin operators;
deploying an interference automaton equation in response to the interference matrix;
performing prefix-loop decomposition to generate a control law; and
outputting the control law.

2. The method of claim 1, wherein outputting the control law comprises outputting the control law to a billboard.

3. The method of claim 1, further comprising computing iterative partial forms of feedback blob transition law as a function of the Dynkin operators.

4. The method of claim 1, further comprising generating feedback decision flow of blob trajectories in response to the control law.

5. An apparatus for wireless communication, the apparatus comprising:
a processor; and
a memory coupled to the processor, the processor configured to cause the apparatus to:
receive criterion dynamics;
construct Dynkin operators in response to the criterion dynamics;
construct an interference matrix in response to the Dynkin operators;
deploy an interference automaton equation in response to the interference matrix;
perform prefix-loop decomposition to generate a control law; and
output the control law.

6. The apparatus of claim 5, wherein the control law is outputted to a billboard.

7. The apparatus of claim 5, wherein the processor is further configured to cause the apparatus to compute iterative partial forms of feedback blob transition law as a function of the Dynkin operators.

8. The apparatus of claim 5, the processor is further configured to cause the apparatus to generate feedback decision flow of blob trajectories in response to the control law.
